(19) United States
(12) Patent Application Publication
(10) Pub. No.: US 2020/0147671 A1
(43) Pub. Date: May 14, 2020

(54) METHOD FOR MANUFACTURING DIFFERENT MATERIAL JOINED MEMBER

(71) Applicant: Kabushiki Kaisha Kobe Seiko Sho (Kobe Steel, Ltd.), Kobe-shi (JP)

(72) Inventor: Tetsu IWASE, Fujisawa-shi (JP)

(73) Assignee: Kabushiki Kaisha Kobe Seiko Sho (Kobe Steel, Ltd.), Kobe-shi (JP)

(21) Appl. No.: 16/613,590

(22) PCT Filed: Jun. 15, 2018
(86) PCT No.: PCT/JP2018/023035

§ 371 Date: Nov. 14, 2019

(30) Foreign Application Priority Data
Jun. 19, 2017 (JP) 2017-119899

(51) Int. Cl. B21J 15/02; B23K 11/20

(52) U.S. Cl. CPC B21J 15/025; B23K 11/20

(57) ABSTRACT

A method for manufacturing a different material joined member comprises: a step of punching a shaft portion of a steel rivet into a light alloy material provided with a solid resin layer on at least one surface thereof; a step of causing a shaft portion tip of the rivet to protrude from the solid resin layer on the light alloy material; a step of laying a steel material over the surface of the light alloy material on the side where the shaft portion tip of the rivet protrudes, with the solid resin layer therebetween; and a step of welding the shaft portion of the rivet with the steel material. Instead of punching the rivet, a hole may be drilled in the light alloy material provided with the solid resin layer together with the solid resin layer, the steel material may be laid over via the solid resin layer, and the shaft portion of the steel rivet may be inserted into the hole.

### TECHNICAL FIELD

The present invention relates to a method for manufacturing a different material joined member.

### BACKGROUND ART

In recent years, fuel economy has been improved by reducing the body weight of transport vehicles such as automobiles to address global environmental problems caused by exhaust gas and the like. To improve safety in automobile body collision while inhibiting weight reduction as little as possible, there are an increasing number of application examples in which some of steel materials conventionally used in an automobile body structure are replaced by light alloy materials, such as aluminum alloy materials and magnesium materials, which are light in weight and exhibit good energy absorption.

Aluminum alloy materials used in an automobile body structure and the like are in the form of a rolled plate material, an extruded material, a forged material, or the like. The use of 6000 series (Al—Mg—Si alloys) and 5000 series (Al—Mg alloys) in accordance with AA (The Aluminum Association) standards or JIS standards for an outer panel, an inner panel, and the like in a large panel structure, such as automobile roof, hood, fender, door, and trunk lid, has been studied.

These aluminum alloy materials need to be used in combination with a steel material (steel member), such as a steel plate originally used for general purposes, unless all parts of an automobile body are made of an aluminum alloy material. It is thus inevitably necessary to join the aluminum alloy material to the steel member.

An adhesive layer may be disposed between an aluminum alloy material and a steel member in order to prevent corrosion (galvanic corrosion) caused by a difference in electric potential between the aluminum alloy material and the steel member and further ensure joining strength. An adhesive in the form of a liquid or being viscous for forming the adhesive layer is applied to the aluminum alloy material or the steel member so that the aluminum alloy material and the steel member are joined to each other. A method for welding an aluminum alloy plate to a steel plate by means of a steel rivet may include a step of welding the aluminum alloy plate to the steel plate with an adhesive layer therebetween (PTL 1).

### CITATION LIST

### Patent Literature

PTL 1: Japanese Patent No. 5983884

### SUMMARY OF INVENTION

### Technical Problem

To join an aluminum alloy plate to a steel plate, an adhesive is normally applied to the surfaces of these workpieces. In the above spot welding, a welding method with an adhesive being removed by pressure application from spot welding electrodes and heat generated by current flow to expose a new surface in a weld site is employed. However, there are variations in the amount of the adhesive applied, and generation of adhesive layer thickness distribution cannot be avoided in a region where the adhesive is in contact with the electrodes. In this case, high electrical resistance parts and low electrical resistance parts are locally generated according to the thickness of the adhesive layer in contact with the electrodes, and a current may concentrate and flow in low electrical resistance parts. As a result, there is a problem in which the current flow state becomes unstable, and it is difficult to form a nugget (melted and solidified portion) with a stable size. There may be a welding method in which the once-applied adhesive is partially removed from only a weld region. In this method, however, it is difficult to expose a clean welding area (metal surface) by partially removing the adhesive having fluidity before solidification. Thus, welding is performed with the adhesive remaining in a welding area, which causes a problem in which it is difficult to stably form a melted and solidified portion required to ensure weld strength.

An object of the present invention is to provide a method for manufacturing a different material joined member, which makes it possible to stably form a melted and solidified portion while assuredly preventing galvanic corrosion in a different material joined member in which materials having a difference in electric potential are joined to each other.

### Solution to Problem

The present invention includes the following embodiments.

(1) A method for manufacturing a different material joined member includes:

a step of piercing a light alloy material having a solid resin layer on at least one surface by using a shaft portion of a steel rivet including a head portion and the shaft portion to cause a shaft portion distal end of the rivet to protrude from the solid resin layer;

a step of laying a steel material on a surface of the light alloy material from which the shaft portion distal end of the rivet protrudes, with the solid resin layer between the steel material and the light alloy material; and

a step of welding the shaft portion of the rivet to the steel material.

According to this method for manufacturing a different material joined member, the light alloy material is joined to the steel material with the solid resin layer therebetween. The interface between the light alloy material and the steel material is thus covered with the solid resin layer to assuredly prevent galvanic corrosion. There is no resin movement to a welding area unlike a liquid resin layer or a viscos resin layer. The welding area is thus stably ensured, and a melted and solidified portion with a stable size can be formed. Therefore, the shaft portion distal end of the rivet and the steel material are favorably welded to each other with the shaft line of the rivet located at the center. Moreover, the light alloy material is pierced by using the shaft portion of the rivet. Thus, the rivet is installed into and fixed to the light alloy material at a time, which simplifies the process.

(2) A method for manufacturing a different material joined member includes:

a step of piercing a light alloy material having a solid resin layer on at least one surface while also piercing the solid resin layer;

a step of laying a steel material on the light alloy material, with the solid resin layer between the steel material and the light alloy material;

a step of inserting a steel rivet including a head portion and a shaft portion into a pierced portion in the light alloy material to cause a distal end of the shaft portion to protrude from the solid resin layer; and

a step of welding the shaft portion of the rivet to the steel material.

According to this method for manufacturing a different material joined member, the light alloy material is joined to the steel material with the solid resin layer therebetween. The interface between the light alloy material and the steel material is thus covered with the solid resin layer to assuredly prevent galvanic corrosion. There is no resin movement to a weld unlike a liquid resin layer or a viscos resin layer. The welding area is thus stably ensured, and a melted and solidified portion with a stable size can be formed. Therefore, the shaft portion distal end of the rivet and the steel material are favorably welded to each other with the shaft line of the rivet located at the center. Moreover, the rivet is installed in the pierced portion after the light alloy material is pierced. Thus, the rivet can be precisely fixed to the light alloy material without greatly deforming the light alloy material in rivet installation.

(3) In the method for manufacturing a different material joined member according to (1) or (2), the rivet and the light alloy material are clinched to each other before the welding.

According to this method for manufacturing a different material joined member, the clinching between the rivet and the light alloy material improves the handleability of the light alloy material in which the rivet has been installed and avoids rivet falling out before the welding step.

(4) In the method for manufacturing a different material joined member according to (3), the clinching is performed by plastic flow of the light alloy material.

According to this method for manufacturing a different material joined member, the plastic flow of the light alloy material enables the rivet to be firmly fixed to the light alloy material.

(5) In the method for manufacturing a different material joined member according to (3), the clinching is performed by plastic deformation of the shaft portion of the rivet.

According to this method for manufacturing a different material joined member, the plastic deformation enables the rivet to be firmly fixed to the pierced portion in the light alloy material.

(6) In the method for manufacturing a different material joined member according to any one of (1) to (5), an end surface of the light alloy material is covered with the solid resin layer.

According to this method for manufacturing a different material joined member, the coverage of the end surface of the light alloy material with the solid resin layer inhibits penetration of moisture from the end surface to assuredly prevent galvanic corrosion.

(7) In the method for manufacturing a different material joined member according to any one of (1) to (6), the welding is resistance spot welding.

According to this method for manufacturing a different material b joined member, resistance spot welding can suppress thermal strain and even enables easy joining of a steel material even in the form of a sheet.

(8) In the method for manufacturing a different material joined member according to any one of (1) to (6), the welding is any one of laser welding, TIG welding, plasma arc welding, and MIG welding.

According to this method for manufacturing a different material joined member, there is no need to sandwich workpieces between electrodes unlike spot welding. This enables processing from one side and thus enables joining in a position in which it is difficult to place spot welding electrodes. Moreover, no shunt current is generated unlike spot welding, and the distance between welding points can be reduced.

### Advantageous Effects of Invention

According to the method for manufacturing a different material joined member of the present invention, it is possible to stably form a melted and solidified portion while assuredly preventing galvanic corrosion.

### BRIEF DESCRIPTION OF DRAWINGS

FIG. 1 is a schematic cross-sectional view of a different material joined member produced by a method for manufacturing a different material joined member according to the present invention.

FIG. 2A is a process explanatory view stepwisely illustrating a first method for manufacturing a different material joined member.

FIG. 2B is a process explanatory view stepwisely illustrating the first method for manufacturing a different material joined member.

FIG. 2C is a process explanatory view stepwisely illustrating the first method for manufacturing a different material joined member.

FIG. 2D is a process explanatory view stepwisely illustrating the first method for manufacturing a different material joined member.

FIG. 3A is a cross-sectional view schematically illustrating resistance spot welding between a light alloy material and a steel material.

FIG. 3B is a cross-sectional view schematically illustrating resistance spot welding between the light alloy material and the steel material.

FIG. 4A is a process explanatory view stepwisely illustrating a second method for manufacturing a different material joined member.

FIG. 4B is a process explanatory view stepwisely illustrating the second method for manufacturing a different material joined member.

FIG. 4C is a process explanatory view stepwisely illustrating the second method for manufacturing a different material joined member.

FIG. 5 is a schematic cross-sectional view of a different material joined member produced by a third manufacturing method.

FIG. 6 is a schematic cross-sectional view illustrating another example rivet installed in a light alloy material.

FIG. 7 is a schematic cross-sectional view of a different material joined member in the case of laser welding of a rivet to a steel material.

FIG. 8A is a schematic cross-sectional view of a different material joined member in the case of MIG welding of a rivet to a steel material.

FIG. 8B is a schematic cross-sectional view of a different material joined member in the case of plasma arc welding of a rivet to a steel material.

FIG. 9 is a perspective view of an automobile body.

FIG. 10 is a cross-sectional view schematically illustrating one example form of implementation of a structure in which a roof panel is attached to a roof side rail.

### DESCRIPTION OF EMBODIMENTS

Embodiments of the present invention will be specifically described below with reference to the drawings.

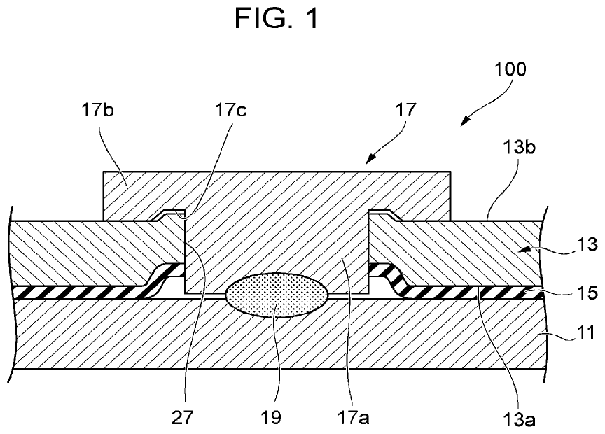

FIG. 1 is a schematic cross-sectional view of a different material joined member 100 produced by a method for manufacturing a different material joined member according to the present invention.

### <Basic Configuration of Different Material Joined Member>

A different material joined member 100 according to this configuration example includes a steel material 11; a light alloy material 13 having, on at least one surface, a solid resin layer 15 with electrical insulation; and a steel rivet 17. The steel material 11 and the light alloy material 13 are laid on top of each other with the solid resin layer 15 therebetween other than the area of a shaft portion 17a of the rivet 17. A distal end of the shaft portion 17a of the rivet 17 is joined to the steel material 11 by spot welding with the light alloy material 13 therebetween to form a melted and solidified portion (nugget for spot welding) 19 in a weld site. The solid resin layer 15 between the steel material 11 and the light alloy material 13 prevents galvanic corrosion caused by a difference in electric potential between the steel material 11 and the light alloy material 13.

### <Rivet>

The rivet 17 includes a shaft portion 17a, and a head portion 17b having a larger diameter than the shaft portion 17a. An insulating layer having a higher electrical resistivity (electrical resistance) than the steel material 11 is formed on the surface of the rivet 17. The insulating layer may be formed of, for example, DISGO (registered trademark), LAFRE (registered trademark), GEOMET (registered trademark), a polyester-based resin precoat, or a silicone elastomer, or a plating layer formed by nickel plating, zinc-nickel plating, zinc plating, and other plating, or may be other insulating coating film. The insulating layer may be formed only in sites on the rivet 17 other than the outer end surface of the head portion 17b of the rivet 17 and the distal end surface of the shaft portion 17a. The insulating layer is formed in at least a region where the rivet 17 is to be in contact with the light alloy material 13 when the rivet 17 is installed in a pierced portion in the light alloy material 13 described below.

The head portion 17b of the rivet 17 may have an annular groove 17c between a surface of the head portion 17b to be in contact with the light alloy material 13 and the circumferential surface on the proximal end side of the shaft portion 17a. When the rivet 17 has the annular groove 17c, plastic flow of part of the light alloy material 13 into the annular groove 17c occurs to improve clinching fastening strength between the rivet 17 and the light alloy material 13.

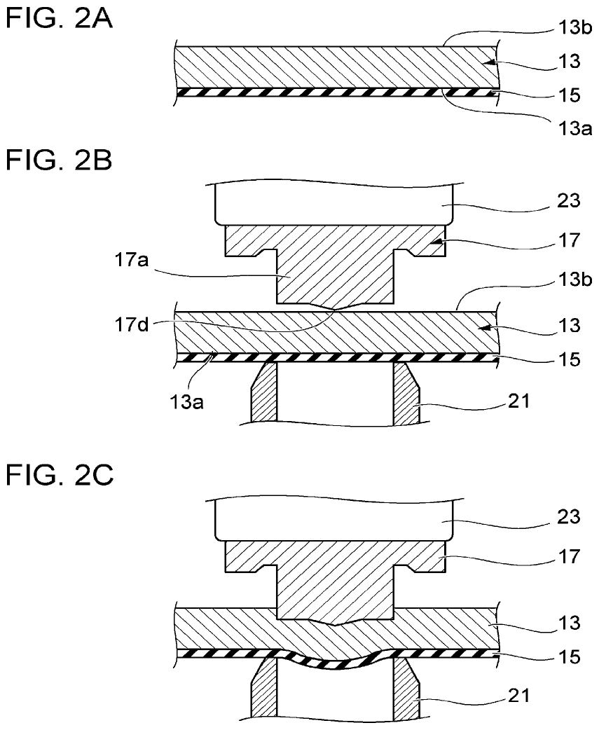

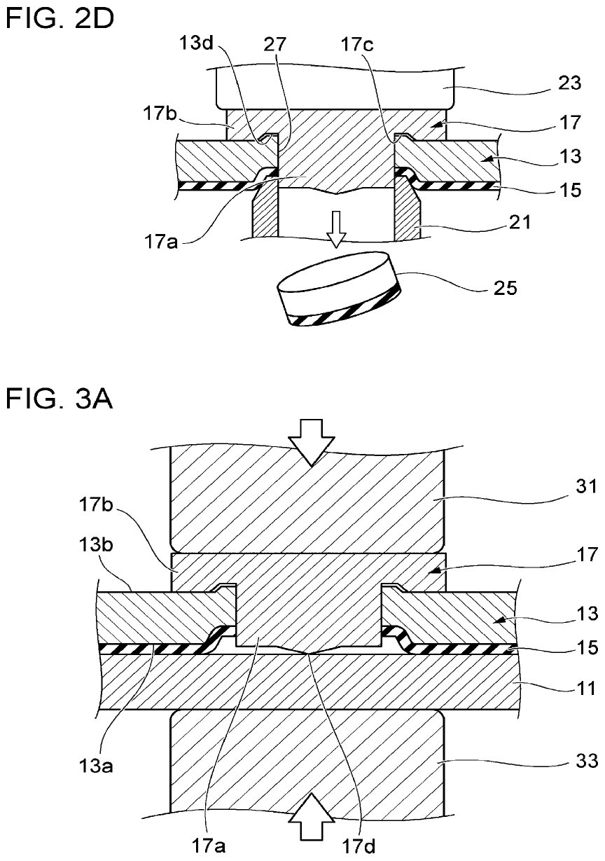

Moreover, as illustrated in FIG. 2B described below, the distal end of the shaft portion 17a of the rivet 17 may have a protrusion (projection) 17d protruding in the axial direction.

### <Steel Material>

The steel material 11 is formed of, for example, a high tensile steel material, a galvanized steel plate, or a stainless steel. Examples of the form of the steel material 11 include plate materials, extrusion profiles, cast materials, press-formed products of plate materials, and hot-stamped products.

### <Light Alloy Material>

Specific examples of the material of the light alloy material 13 include, but are not limited to, aluminum, aluminum alloys (2000 series, 3000 series, 4000 series, 5000 series, 6000 series or 7000 series, 8000 series in accordance with JIS standards), magnesium, and magnesium alloys. Examples of the form of the light alloy material 13 include plate materials (including aluminum clad materials), extrusion profiles, die cast materials, cast materials, and press-formed products of rolled plate materials and extruded materials.

### <Solid Resin Layer>

The solid resin layer 15 has electrical insulation as described above and is disposed on at least one surface 13a of the light alloy material 13. The solid resin layer 15 having this configuration is formed in a region on a surface of the light alloy material 13, the region surrounding at least the shaft portion 17a of the rivet 17, the surface facing the steel material 11. The solid resin layer 15 preferably has good shearing properties and is preferably pierced together with the light alloy material 13. Specifically, the solid resin layer 15 is preferably a resin adhesive tape, or a laminated film having a polyester resin film bonded by thermocompression.

More preferably, the solid resin layer 15 is a resin adhesive tape (film tape). With regard to the materials of the resin adhesive tape, various resin materials, such as polyurethane, polyester, ionomers, and PET, can be used as the substrate of the tape. Ionomers are preferably used for the resin adhesive tape from the viewpoint of weather resistance, heat resistance, water resistance, and ease in piercing. The solid resin layer 15 is disposed on a surface of the light alloy material 13 that faces the steel material 11. However, the solid resin layer 15 may be disposed only around the shaft of the rivet 17, and an adhesive layer may be disposed in a region other than the solid resin layer 15.

The solid resin layer 15 can be formed of a resin adhesive tape or a laminated film. The solid resin layer 15 may be a dry coating film formed by applying a coating resin with a roll coater or a bar coater and then drying the coating resin. A resin adhesive tape allows the solid resin layer 15 to be partially disposed in a given position. A laminated film or a dry coating film formed of a coating resin is suitable for forming the solid resin layer 15 with a large area. The thickness of the solid resin layer 15 is preferably about 0.01 to 0.6 mm, and more preferably 0.2 to 0.5 mm. With the thickness in this range, the light alloy material 13 and the solid resin layer 15 can be integrally pierced by shearing such as piercing while electrical insulation between the light alloy material and the steel material is ensured.

<Method for Manufacturing Different Material Joined Member>

### (First Manufacturing Method)

Next, a first method for manufacturing the different material joined member 100 will be described.

FIG. 2A, FIG. 2B, FIG. 2C, and FIG. 2D are process explanatory views stepwisely illustrating the first method (piercing method) for manufacturing the different material joined member 100 illustrated in FIG. 1.

First, as illustrated in FIG. 2A, the solid resin layer 15 is disposed on the light alloy material 13. In the illustrated example, the solid resin layer 15 is disposed on a lower surface 13a (in the figure) of the light alloy material 13, but may also be disposed on an upper surface 13b in the figure.

Next, as illustrated in FIG. 2B, the light alloy material 13 having the solid resin layer 15 is placed on a cylindrical lower die 21, and the rivet 17 is disposed between the lower die 21 and an upper die (punch) 23. In this case, the light alloy material 13 is disposed in such a manner that the surface 13a of the light alloy material 13 that has the solid resin layer 15 faces the lower die 21.

As illustrated in FIG. 2C, the rivet 17 is struck into the light alloy material 13 by relatively moving the lower die 21 and the upper die 23. As illustrated in FIG. 2D, the light alloy material 13 is pierced by using the shaft portion 17a of the rivet 17, and a slug (blank) 25 falls down into the lower die 21. The distal end of the shaft portion 17a of the rivet 17 penetrates the light alloy material 13 in the thickness direction and protrudes from the light alloy material 13. In this state, a pierced portion 27 without the solid resin layer 15 is formed in the light alloy material 13.

At the same time as the slug 25 is punched out, the material of the light alloy material 13 around the pierced portion 27 is sandwiched between the head portion 17b of the rivet 17 and the lower die 21 to cause plastic flow and flows into the annular groove 17c formed in the head portion 17b of the rivet 17. As a result, the light alloy material 13d undergoing plastic flow comes in close contact with the annular groove 17c of the rivet 17, and the rivet 17 is clinched to the light alloy material 13.

Next, the light alloy material 13 to which the rivet 17 has been clinched is joined to the steel material 11 by resistance spot welding.

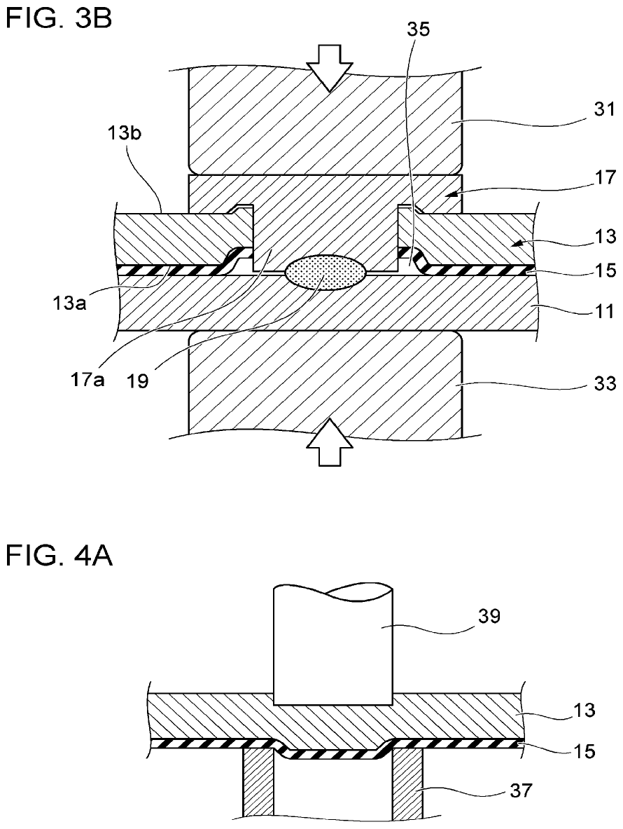

FIG. 3A and FIG. 3B are cross-sectional views schematically illustrating resistance spot welding between the light alloy material 13 and the steel material 11.

First, as illustrated in FIG. 3A, the light alloy material 13 to which the rivet 17 has been clinched is laid on the steel material 11 in such a manner that the surface 13a from which the shaft portion 17a of the rivet 17 protrudes faces the steel material 11. In other words, the light alloy material 13 is laid on the steel material 11 with the solid resin layer 15, which is formed on one surface 13a of a pair of opposed surfaces 13a and 13b, therebetween.

The head portion 17b and the steel material 11 of the rivet 17 are then sandwiched between spot welding electrodes 31 and 33 of a resistance spot welding machine, and a pressing force is applied between the spot welding electrodes 31 and 33. Subsequently, as illustrated in FIG. 3B, resistance spot welding between the rivet 17 and the steel material 11 is performed by applying a welding current between the spot welding electrodes 31 and 33. Accordingly, a melted and solidified portion 19 is formed between the distal end of the shaft portion 17a of the rivet 17 and the steel material 11.

In spot welding, the solid resin layer 15 is absent on a surface (welding area) of the rivet 17 in contact with the steel material 11. In addition, the pressure application and heat during welding do not cause the flow of the solid resin layer 15 to the joint surface. Moreover, the insulating layer formed on the surface of the rivet 17 is not peeled off and is present on surfaces of the rivet 17 in contact with the light alloy material 13, that is, the outer circumferential surface of the shaft portion 17a of the rivet 17 and the lower surface of the head portion 17b.

Therefore, the current flow between the spot welding electrodes 31 and 33 is not inhibited by the solid resin layer 15 nor shunted from the rivet 17 to the light alloy material 13. The current flows through the rivet 17 toward the steel material 11. The welding current thus concentrates in a region centered on the shaft portion 17a of the rivet 17, and the melted and solidified portion 19 with a desired size is formed at the center of the shaft portion 17a.

In the case where the distal end of the shaft portion 17a of the rivet 17 has a protrusion 17d, the protrusion 17d in a central position of the shaft portion 17a assuredly comes in contact with the steel material 11, and the current flowing through the rivet 17 thus tends to flow to a region centered on the protrusion 17d. Accordingly, the appropriate melted and solidified portion 19 is stably formed with the shaft portion 17a located at the center.

As illustrated in FIG. 3B, the light alloy material 13 is deformed from one surface 13a side toward the other surface 13b side by piercing with the lower die 21 illustrated in FIG. 2D. As a result, a recess 35 recessed upward in the figure is formed on the surface 13a of the light alloy material 13.

The recess 35 serves as a heat insulation space that separates the light alloy material 13 from a part where the melted and solidified portion 19 is formed between the distal end of the shaft portion 17a of the rivet 17 and the steel material 11. As a result, the heat from the melted and solidified portion 19 is unlikely to be transmitted to the light alloy material 13. The heat from the melted and solidified portion 19 is also unlikely to be transmitted to the solid resin layer 15 formed on the light alloy material 13. This can suppress heat damage on the solid resin layer 15. Therefore, the melted and solidified portion 19 is appropriately formed by spot welding between the rivet 17 and the steel material 11.

According to the different material joined member 100 having this configuration, the solid resin layer 15 is absent in a welding area (weld region) between the distal end surface of the shaft portion 17a of the rivet 17 and the steel material 11 during spot welding. The absence of the solid resin layer 15 can stabilize welding current. Therefore, a melted and solidified portion with a stable size can be formed while the galvanic corrosion of the light alloy material 13 and the steel material 11 is avoided assuredly.

If the light alloy material 13 and the steel material 11 are temporarily joined to each other before welding by using a liquid adhesive or a viscos adhesive known in the related art, the adhesive is not completely removed, and the adhesive remains in the welding area. If the workpieces are pierced with the adhesive having fluidity before solidification of the adhesive applied to the light alloy material 13, the adhesive flows to the welding area immediately after piercing. In such a case, the distal end surface of the shaft portion 17a of the rivet 17 and a surface of the steel material 11 that faces the distal end surface are at least partially covered by the adhesive, which makes it difficult to obtain a melted and solidified portion with an appropriate size.

Thus, the resin layer formed on the light alloy material 13 needs to be solid when being pierced together with the light alloy material 13. When the resin layer is solid, the resin itself does not flow, and the joint surface (joint region) corresponding to the cross section (the cross section perpendicular to the axial direction) of the shaft portion 17a of the rivet 17 is obtained.

In the case where a resin adhesive tape or a polyester resin film is used as the solid resin layer 15, the solid resin layer 15 having a uniform thickness can be efficiently formed with no skill by simply sticking the tape or film. Therefore, automation is easily possible, which simplifies the process for manufacturing the different material joined member and improves the efficiency of the process.

The spot welding conditions can be the conditions widely used for ordinary joining between the same materials of steel material-steel material. In other words, according to this configuration, the conditions widely used for ordinary spot welding between the same materials of steel material-steel material can be used in spite of different material joining between the light alloy material 13 and the steel material 11. With regard to the spot welding conditions, the pressing force between a pair of spot welding electrodes is preferably in the range from 1.0 to 7.0 kN. The inter-electrode current is in the range from 5 to 15 kA, and preferably in the range from 7 to 8 kA, and the current preferably flows for a time of 200×t (msec) or shorter because of the thickness t (mm) of the light alloy material 13 in the welding area.

### (Second Manufacturing Method)

Next, a second method for manufacturing the different material joined member 100 will be described.

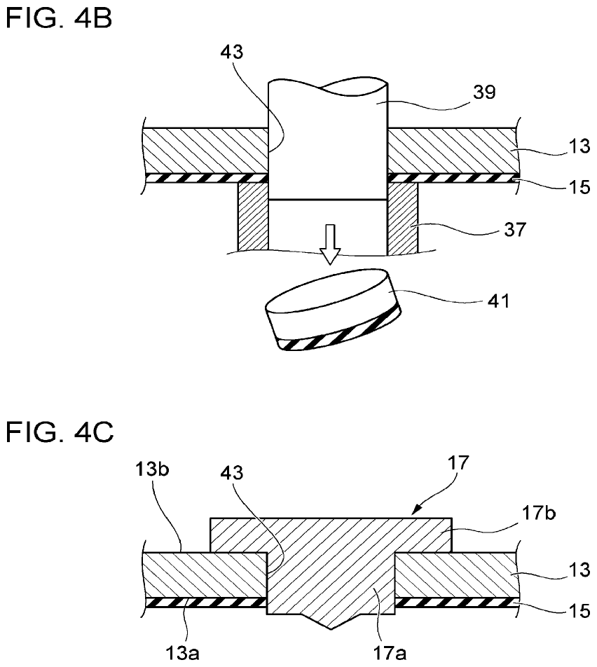

FIG. 4A, FIG. 4B, and FIG. 4C are process explanatory views stepwisely illustrating the second method for manufacturing the different material joined member 100.

As illustrated in FIG. 4A, a light alloy material 13 having a solid resin layer 15 on at least one surface is disposed between a cylindrical lower die 37 and a cylindrical upper die 39. The upper die 39 and the lower die 37 are relatively moved so as to come close to each other. As illustrated in FIG. 4B, the light alloy material 13 and the solid resin layer 15 are pierced together, and a slug (blank) 41 falls down into the lower die 37. Accordingly, a pierced portion 43 serving as a pilot hole is formed in the light alloy material 13.

Next, as illustrated in FIG. 4C, a shaft portion 17a of the rivet 17 fits into the pierced portion 43 formed in the light alloy material 13. The rivet 17 fits into the pierced portion 43, which serves as a pilot hole having a slightly larger diameter than the pierced portion 43, from a surface 13b opposite to a surface 13a on which the solid resin layer 15 is formed. Accordingly, the rivet 17 is clinched to the light alloy material 13 in association with the plastic flow of the light alloy material 13 described above. The rivet 17 may be fixed to the light alloy material 13 in such a manner that the shaft portion 17a simply enlarges the diameter of the pierced portion 43 in the light alloy material 13 and press-fits into the pierced portion 43, or the shaft portion 17a of the rivet 17 may simply be inserted to the pierced portion 43.

The description of the steps after this process is omitted because the steps after this process are the same as the resistance spot welding using the resistance spot welding machine illustrated in FIG. 3A and FIG. 3B described above.

According to this manufacturing method, the installation of the rivet 17 is completed only by causing the shaft portion 17a of the rivet 17 to fit into the pierced portion 43 in the light alloy material 13. There is thus no need to apply a large pressing force when punching the rivet 17. As a result, a C-flame to which the rivet is to be installed may have low stiffness, and a rivet setting device may have a compact size.

### (Third Manufacturing Method)

Next, a third method for manufacturing the different material joined member will be described.

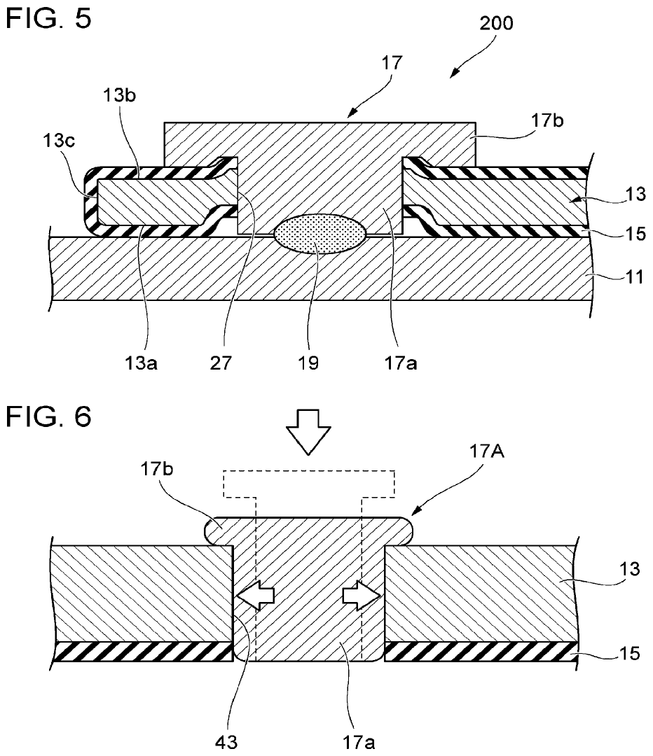

FIG. 5 is a schematic cross-sectional view of a different material joined member 200 produced by a third manufacturing method.

In the different material joined member 200 in this case, a solid resin layer 15 is continuously formed on one surface 13a of a light alloy material 13, an end surface 13c continuous with the surface 13a, and the other surface 13b continuous with the end surface 13c. The other components are the same as those in the different material joined member 100 illustrated above in FIG. 1.

Since the end portion of the light alloy material 13 including the end surface 13c is covered with the solid resin layer 15 according to the different material joined member 200 having this configuration, the progress of galvanic corrosion caused by penetration of moisture from the end surface 13c or the like can be inhibited assuredly. In addition to the form where the surfaces 13a and 13b as well as the end surface 13c are covered with the solid resin layer 15 as in the illustrated example, the form where the surface 13a and the end surface 13c are covered with the solid resin layer 15 may be employed. Even in such a case, the effect of preventing galvanic corrosion from the end surface 13c is improved.

### Modification

Next, still another example method for manufacturing a different material joined member will be described.

The clinching form between the rivet 17 and the light alloy material 13 as described above is associated with plastic flow of the light alloy material 13 or involved in rivet fitting, but may be other clinching form.

FIG. 6 is a schematic cross-sectional view illustrating another example rivet installed in a light alloy material 13.

A shaft portion 17a of a rivet 17A before clinching indicated by the dotted line in the figure is inserted into a pierced portion 43 formed in the light alloy material 13. The head portion 17b of the rivet 17A is pressed in the axial direction so that the shaft portion 17a projects due to plastic deformation and comes in close contact with the inner wall surface of the pierced portion 43.

Accordingly, the rivet 17A may be clinched to the light alloy material 13 in such a manner that the shaft portion 17a projects due to plastic deformation. The illustrated example shows a simple rivet shape, but the shaft portion 17a of the rivet 17A may be such that the outer circumferential surface has a tapered shape or a barrel shape, in addition to the shaft portion having a cylindrical shape.

In this configuration, the rivet 17A is clinched to the pierced portion 27 without causing the plastic flow of the light alloy material 13. Therefore, the rivet 17A can be firmly fixed to the light alloy material 13 while great deformation (e.g., warpage) of the light alloy material 13 is suppressed.

The above configuration examples describe the forms of implementation where the rivet 17 or 17A is joined to the steel material 11 by resistance spot welding, but the welding method is not limited to this method. The welding method may be, for example, laser welding, MIG welding, TIG welding, or plasma arc welding.

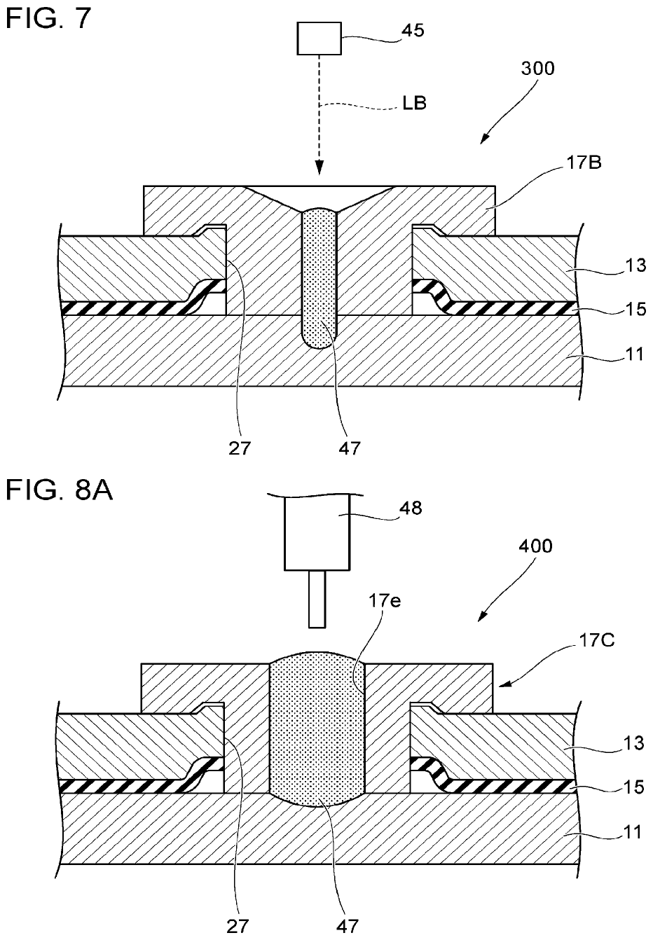

FIG. 7 is a schematic cross-sectional view of a different material joined member 300 in the case of laser welding of a rivet 17B to a steel material 11.

In the case of laser welding, a melted and solidified portion 47 is formed by using a laser beam LB outputted from a laser oscillator 45. The melted and solidified portion 47 penetrates the rivet 17B and joins the rivet 17B to the steel material 11.

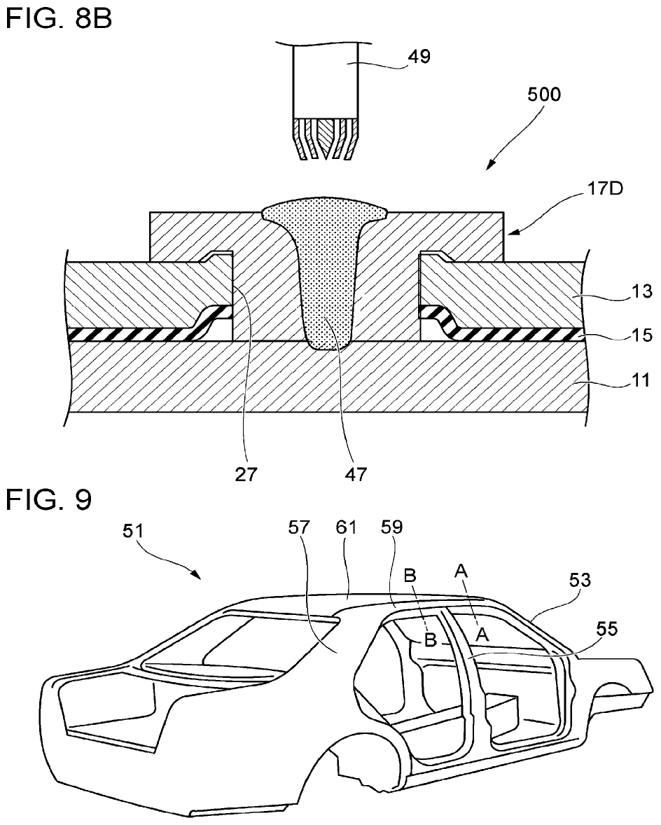

FIG. 8A is a cross-sectional view of a different material joined member 400 in the case of MIG welding of a rivet 17C to a steel material 11.

In the case of MIG welding, an arc from a welding torch 48 causes a base metal and a filler metal to melt in a shielding gas atmosphere, so that a melted and solidified portion 47 accumulates in an opening 17e formed in the rivet 17C.

FIG. 8B is a cross-sectional view of a different material joined member 500 in the case of plasma arc welding of a rivet 17D to a steel material 11.

In plasma arc welding, a welding torch 49 generates a plasma arc converged by using a thermal pinch effect caused by a plasma gas and a constricting nozzle. The plasma arc forms a melted and solidified portion 47. The melted and solidified portion 47 penetrates the rivet 17D and joins the rivet 17D to the steel material 11. Although not illustrated, the same effect as that obtained by plasma arc welding is obtained even by TIG welding.

According to laser welding, TIG welding, plasma arc welding, and MIG welding, there is no need to sandwich workpieces between electrodes unlike spot welding. This enables processing from one side and thus enables joining in a position in which it is difficult to place spot welding electrodes. Moreover, no shunt current is generated unlike spot welding, and the distance between welding points can be reduced.

### <Application Example of Different Material Joined Member>

Next, an example where the configuration of the different material joined member described above is applied to an automobile roof-attached structure will be described.

FIG. 9 is a perspective view of an automobile body.

As in the illustrated example, the basic structure of an automobile body 51, which is set forth as a premise, is the same as a conventional structure. Specifically, paired roof side rails 59 extending in the vehicle longitudinal direction are disposed on both sides of the vehicle upper part on the upper side of a front pillar 53, a center pillar 55, and a rear pillar 57. In the vehicle upper part, a roof panel 61 is placed between the paired roof side rails 59.

The roof panels 61 according to this configuration is made of an aluminum alloy (plate), and the roof side rail 59 is made of steel.

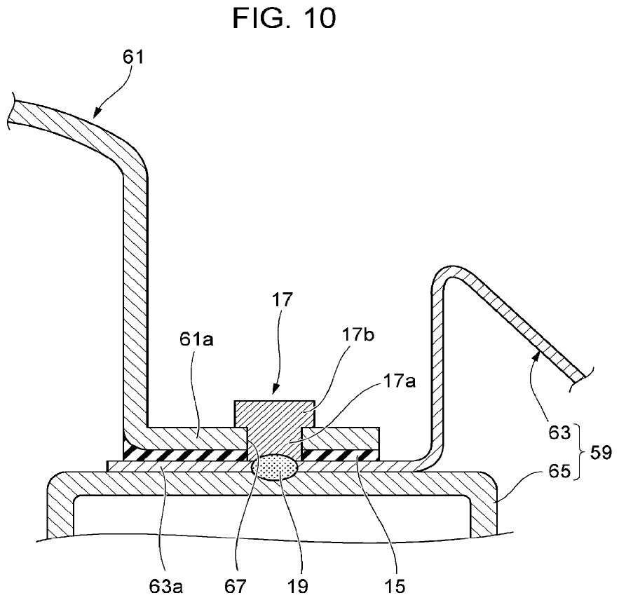

FIG. 10 is a cross-sectional view schematically illustrating one example form of implementation of a structure in which the roof panel 61 is attached to the roof side rail 59.

The cross-sectional view of the illustrated example corresponds to the cross-sectional view taken along line A-A between the front pillar 53 and the center pillar 55 or line B-B between the center pillar 55 and the rear pillar 57 on the both sides of the roof panel 61 in the vehicle transverse direction in the perspective view of the automobile body 51 illustrated in FIG. 9. Here, the structure of the roof side rail 59 including a side panel outer 63 and a roof rail inner 65 is illustrated, but the roof side rail 59 is not limited to this structure. The roof side rail 59 may be a composite member in which another member is further joined to the roof rail inner 65.

The rivet 17 is made of steel, which is the same as the material of the side panel outer 63 and the roof rail inner 65. The rivet 17 has a shaft portion 17a and a head portion 17b.

The periphery of the roof panel 61 has a flange portion 61a for connection with the roof side rail 59 side. A solid resin layer 15 is formed on a surface of the flange portion 61a that faces the side panel outer 63. The flange portion 61a has a pierced portion 67 into which the shaft portion 17a of the rivet 17 is inserted. The pierced portion 67 may be formed by punching the shaft portion 17a of the rivet 17 or may be a pilot hole pierced in advance.

The periphery of the side panel outer 63 also has a flange portion 63a. The flange portion 63a of the side panel outer 63, the roof rail inner 65, and the flange portion 61a of the roof panel 61 are laid on top of one another.

The head portion 17b of the rivet 17 is in contact with the upper surface of the roof panel 61, and the distal end of the shaft portion 17a is in contact with the side panel outer 63 through the pierced portion 67. The shaft portion 17a or the head portion 17b of the rivet 17 is clinched to the roof panel 61 as described above. A region between the head portion 17b of the rivet 17 and the roof rail inner 65 of the roof side rail 59 is sandwiched between a pair of spot welding electrodes of a resistance spot welding machine to apply a current. A melted and solidified portion 19 is thus formed in a region defined by the shaft portion 17a of the rivet 17, the side panel outer 63, and the roof rail inner 65.

In other words, the roof side rail 59 made of a steel material and the roof panel 61 made of a light alloy material are joined to each other by welding the roof side rail 59 and the steel rivet 17 made of steel to each other.

Since the solid resin layer 15 is disposed between the roof side rail 59 and the roof panel 61, occurrence of galvanic corrosion is avoided assuredly. Since the distal end of the shaft portion 17a of the rivet 17 is in direct contact with the roof side rail 59, a melted and solidified portion with a stable size can be formed without a problem of adhesive flow.

The above application example of the different material joined member is illustrative only, and the present invention is not limited to this example. The present invention can also be applied to other joints in, for example, hoods, fenders, doors, and trunk lids. Moreover, the configuration of the different material joined member of the present invention can also be applied to joints in various transport vehicles, such as railroad cars, airplanes, and ships.

The present invention is not limited to the embodiments described above. It should be understood that the configurations of the embodiments of the present invention are combined with each other or the present invention is modified and applied by those skilled in the art on the basis of the description of the specification and well-known techniques. These combinations, modifications, and applications are within the scope of the claims.

The present application claims priority from a Japanese patent application (Japanese Patent Application No. 2017-119899) filed Jun. 19, 2017, the contents of which are hereby incorporated by reference.

### REFERENCE SIGNS LIST

11 Steel material
13 Light alloy material
13a Surface (rivet pierced side)
15 Solid resin layer
17 Rivet
17a Shaft portion
27 Pierced portion
100, 200, 300, 400 Different material joined member

1. A method for manufacturing a different material joined member, the method comprising:
piercing a light alloy material having a solid resin layer on at least one surface by using a shaft portion of a steel rivet including a head portion and the shaft portion to cause a shaft portion distal end of the rivet to protrude from the solid resin layer;
laying a steel material on a surface of the light alloy material from which the shaft portion distal end of the rivet protrudes, with the solid resin layer between the steel material and the light alloy material; and
welding the shaft portion of the rivet to the steel material.

2. A method for manufacturing a different material joined member, the method comprising:
piercing a light alloy material having a solid resin layer on at least one surface while also piercing the solid resin layer;
laying a steel material on the light alloy material, with the solid resin layer between the steel material and the light alloy material;
inserting a steel rivet including a head portion and a shaft portion into a pierced portion in the light alloy material to cause a distal end of the shaft portion to protrude from the solid resin layer; and
welding the shaft portion of the rivet to the steel material.

3. The method according to claim 1, wherein the rivet and the light alloy material are clinched to each other before the welding.

4. The method according to claim 2, wherein the rivet and the light alloy material are clinched to each other before the welding.

5. The method according to claim 3, wherein the rivet and the light alloy material are clinched by plastic flow of the light alloy material.

6. The method according to claim 4, wherein the rivet and the light alloy material are clinched by plastic flow of the light alloy material.

7. The method according to claim 3, wherein the rivet and the light alloy material are clinched by plastic deformation of the shaft portion of the rivet.

8. The method according to claim 4, wherein the rivet and the light alloy material are clinched by plastic deformation of the shaft portion of the rivet.

9. The method according to claim 1, wherein an end surface of the light alloy material is covered with the solid resin layer.

10. The method according to claim 1, wherein the welding is resistance spot welding.

11. The method according to claim 9, wherein the welding is resistance spot welding.

12. The method according to claim 1, wherein the welding is any one of laser welding, TIG welding, plasma arc welding, and MIG welding.

13. The method according to claim 9, wherein the welding is any one of laser welding, TIG welding, plasma arc welding, and MIG welding.
